(19) United States
(12) Patent Application Publication
(10) Pub. No.: US 2022/0287501 A1
(43) Pub. Date: Sep. 15, 2022

(54) Comestible Roasting Tool

(71) Applicant: Andreas Biela, Chilliwack (CA)

(72) Inventor: Andreas Biela, Chilliwack (CA)

(21) Appl. No.: 17/200,963

(22) Filed: Mar. 15, 2021

(51) Int. Cl. A47J 37/04

(52) U.S. Cl. CPC A47J 37/049

(57) ABSTRACT

A tool for use with food items; the tool includes a rod and a removable, disposable skewer. The skewer is removably inserted into a skewer-holder-end of the rod and held in place therein. The skewer is then used for holding a food item and roasting or cooking it over a heat source. Preferably, the tool is used for holding a food item such as a marshmallow and roasting it over a campfire.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of food handling tools of existing art and more specifically relates to a tool for use in roasting or cooking food, particularly using an open flame such as a campfire.

### RELATED ART

Roasting food over a campfire is a well-known element of camping and picnicking and is even a fun activity for families and couples to enjoy at home in their backyard; however, this method of cooking presents many difficulties. Often, a camper or picnic goer will find and utilize a branch harvested from the area. Many issues arise from this, as the branch may not be clean, not allergy safe, and simply is not a suitable tool for properly roasting and cooking food.

Roasting tools have been provided in the art to attempt to solve this problem. However, these attempts have not been satisfactory, as the tools typically require cleaning after every use and therefore potentially result in cross contamination if not properly cleaned; get too hot from the flame and therefore have to cool down before eating and are not particularly safe for children; are too short resulting in potential harm to a user's hand, etc. Thus, a suitable solution is desired.

### SUMMARY OF THE INVENTION

In view of the foregoing disadvantages inherent in the known food handling tool art, the present disclosure provides a novel comestible roasting tool. The general purpose of the present disclosure, which will be described subsequently in greater detail, is to provide an improved tool for aiding in cooking or roasting food items over a heat source such as a campfire.

A tool for use with food items is disclosed herein. The tool includes a rod which may have a body being at least partially hollow and defining an inner-capacity. The rod may include a skewer-holder-end including an opening permitting entrance to the inner-capacity and configured to removably receive at least a portion of a skewer therein. A holding-means may be located about the skewer-holder-end which is configured to hold the at least said portion of the skewer in the skewer-holder-end of the rod. A handle-end may be located opposite the skewer-holder-end and may include a handle. The rod may further include an elongated length between the skewer-holder-end and the handle-end.

According to another embodiment, a method of using a tool with food items is also disclosed herein. The method includes providing the tool as above; inserting a second-end of the skewer into the opening until the holding-means holds the at least said portion of the skewer in the skewer-holder-end of the rod; inserting a first-end of the skewer into a food item, the first-end including a spike for holding the food item; holding the handle of the rod; and holding the food item over a heat source to cook the food item.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a comestible roasting tool, constructed and operative according to the teachings of the present disclosure.

FIG. 1 is a side perspective view of the tool during an ‘in-use’ condition, according to an embodiment of the disclosure.

FIG. 2A is a side view of the tool of FIG. 1, illustrating the tool including a handle, a rod, and a skewer removably inserted into the rod, according to an embodiment of the present disclosure.

FIG. 2B is a side view of the tool of FIG. 2A, illustrating the rod being substantially hollow, according to an embodiment of the present disclosure.

FIG. 3 is a side front perspective view of the tool of FIG. 1, illustrating the skewer being removed from the rod and comparative sizes of a skewer-holder-end of the rod and the skewer, according to an embodiment of the present disclosure.

FIG. 4 is a side sectioned perspective view of the tool of FIG. 1, illustrating the holding-means including the section of the rod, the section being tapered, according to an embodiment of the present disclosure.

FIG. 5 is a side sectioned perspective view of the tool of FIG. 1, illustrating the section of the rod, the skewer-holder-end being swaged and the section being tapered, according to another embodiment of the present disclosure.

FIG. 6 is a side sectioned perspective view of the tool of FIG. 1, illustrating the section of the rod, the section being stepped, according to another embodiment of the present disclosure.

FIG. 7 is a side sectioned perspective of the tool of FIG. 1, illustrating the section of the rod, the section being crimped, according to another embodiment of the present disclosure.

FIG. 8 is a side sectioned perspective view of the tool of FIG. 1, illustrating the holding-means located within the section the rod, the holding-means including a socket-means, according to another embodiment of the present disclosure.

FIG. 9 is a flow diagram illustrating a method of using a tool with food items, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a food handling tool and more particularly to a tool used to improve means of cooking and roasting of food items over a heat source, such as an open flame. Generally disclosed is a tool which may include a hollow and rigid tube preferably made of a stainless-steel material. The rod may be approximately 27 inches long. The stainless steel is durable, rust-resistant, re-usable and food and allergy safe. Further, the tool may include a wooden handle on one end. On an opposite end the tube may include an opening allowing access to a hollow inner of the tube and configured to accommodate an insertable and disposable rigid wooden skewer which is configured to hold a food item. The food item may then be placed over the heat source. Only the skewer may contact the heat source, and as such, the tube will not heat up substantially.

The opening (and hollow inner) may be approximately 3/16 inch in diameter to accommodate a 3/16 inch diameter skewer. Once the skewer is soiled it may then be removed and replaced with a new clean one. The skewer and the handle may be made from a food and allergy safe wood. The rod may include a means for holding the skewer therewithin. For example, the rod may be crimped at approximately 2 inches from the end with the opening to hold the skewer, preventing it from falling out of the rod or falling further into the rod. In other embodiments, the rod may include a tapered inner diameter, a stepped inner diameter, a swaged diameter, or a socket for “plugging” the skewer thereinto.

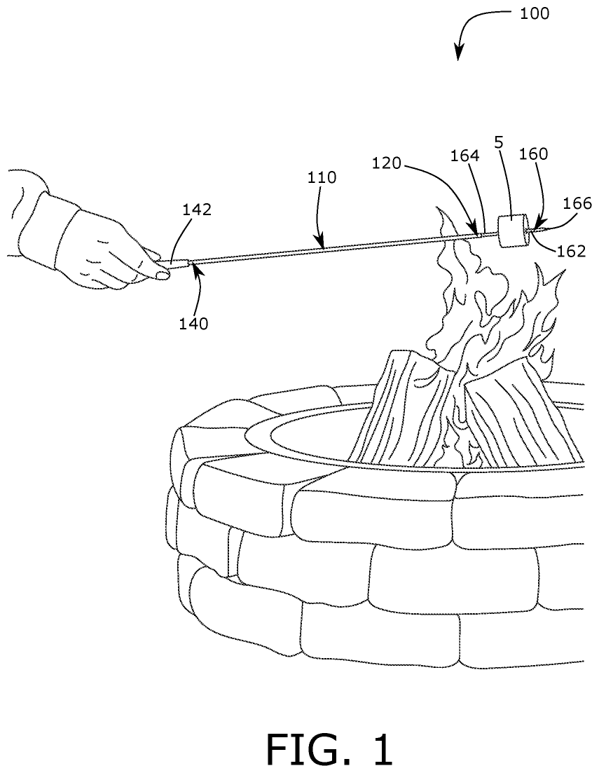

Referring now more specifically to the drawings by numerals of reference, there is shown in FIGS. 1-8, various views of a tool for use with food items (“tool” 100).

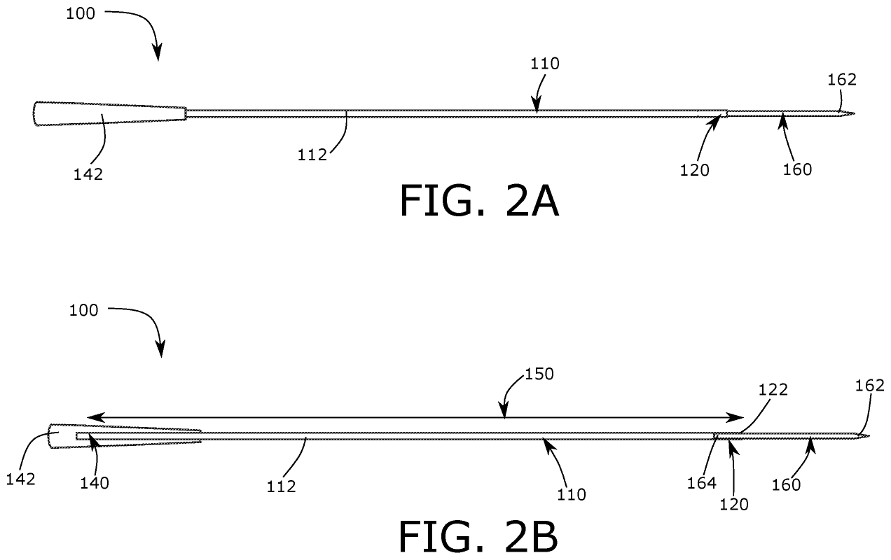

As illustrated in FIG. 1, the tool 100 may be used with food items 5. Particularly, the tool 100 may be used for aiding in cooking or roasting a food item over a heat source, such as an open flame. For example, the tool 100 may be used for roasting marshmallows, hot dogs, etc. over a fire. The tool 100 may include a rod 110 including at least a skewer-holder-end 120, a handle-end 140 opposite the skewer-holder-end 120. Further, the tool 100 may further include a skewer 160 attachable to the skewer-holder-end 120 of the rod 110. The skewer 160 may be directly attachable to the food item 5. As shown in FIGS. 2A-2B, the rod 110 may include an elongated length 150 between the skewer-holder-end 120 and the handle-end 140. In some embodiments, the elongated length 150 may be between 25-30 inches. In one example, the elongated length 150 may be approximately 27 inches. The elongated length 150 of the rod 110 may enable a user to hold only the skewer 160 over the heat source, thereby preventing the rod 110 from becoming too hot.

Further, the handle-end 140 may include a handle 142. The handle 142 preferably be made from a material that is non heat conductive. For example, the handle 142 may be made from a wood material. However, whether the wood material, or a different material, it is contemplated that the handle 140 may be made from food safe and allergy safe materials or may at least comprise food and allergy safe properties to the material.

The rod 110 may include a body 112 being at least partially hollow and defining an inner-capacity 114. Preferably, the rod 110 may be substantially hollow, as shown in FIG. 2B. The rod 110 may be reusable, and like the handle 142, may be made from a food safe and allergy safe material, or again, at least comprise food and allergy safe properties. In some embodiments, the rod 110 may comprise a substantially metal material. For example, the substantially metal material may be stainless steel. In this example the stainless steel may be grade 304 stainless steel, grade 316 stainless steel, grade 430 stainless steel, or the like.

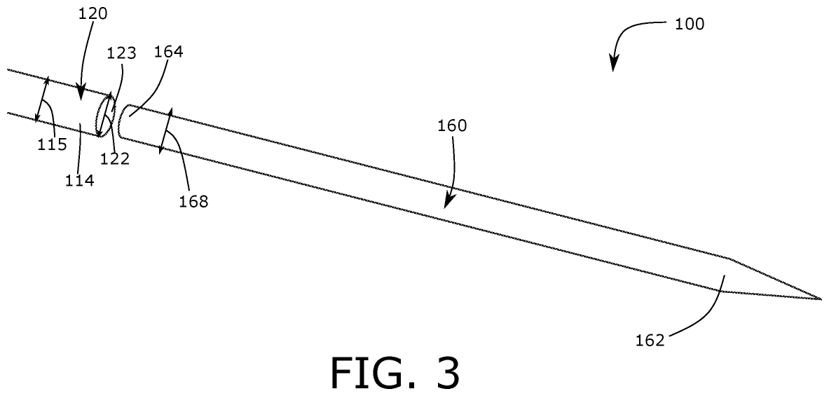

As shown in FIG. 3, the skewer-holder-end 120 may include an opening 122 permitting entrance to the inner-capacity 114 of the rod 110. The opening 122 may be configured to removably receive at least a portion of the skewer 160 therein. For example, the skewer may include a first-end 162 opposite a second-end 164, the first-end 162 may include a spike 166 for holding the food item 5 (as shown in FIG. 1), and the second-end 164 may be configured for insertion into the skewer-holder-end 120. In some embodiments, the skewer 160 may be provided with the tool 100. For example, in some embodiments, a plurality of skewers and the rod 110 may be provided as a kit. In other embodiments, the rod 110 may be configured for use with any standard skewer.

As above, and as shown in FIG. 1, the skewer 160 may be directly removably attached to the food item 5 and may be held over the heat source, as shown. As such, preferably, the skewer 160 may be disposable. In this embodiment, the skewer 160 may be removed from the rod 110 and disposed of when it becomes soiled. A fresh skewer may then be inserted into the rod 110 (via the skewer-holder-end 120). The skewer 160 may be made from a material such as a wood material. In some embodiments, the skewer 160 may be made from a first wood material and the handle 142 may be made from a second wood material. The first wood material and the second wood material may be the same in some embodiments or different in other embodiments. The skewer 160 may be preferably made from or include food safe and allergy safe properties.

As shown in FIG. 3, the opening 122 may include an opening-diameter 123 and the inner-capacity 114 may include an inner capacity-diameter 115. In some embodiments, the opening-diameter 123 and the inner capacity-diameter 115 may be substantially equal to a skewer-diameter 168 of the skewer 160 (as measured at the second-end 164 of the skewer 160). It is contemplated that the opening-diameter 123 and the inner capacity-diameter 115 may be sized such that the skewer 160 is easily slid thereinto but is not too ‘loose’ (loosely fit) therewithin. In some examples, the opening-diameter 123 and the inner capacity-diameter 115 may be between 3-5 mm. In other examples, the opening-diameter 123 and the inner capacity-diameter 115 may be 3/16^{th} inches. As such, the skewer-diameter 168 (again, as measured at the second-end 164 of the skewer 160) may also be 3/16^{th} inches, slightly smaller or slightly bigger. In other embodiments the (general) inner capacity-diameter 115 and the opening-diameter

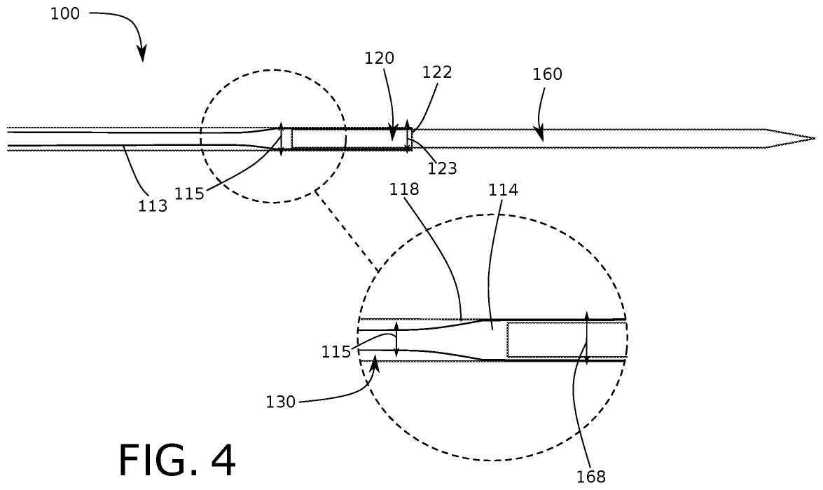

As shown in FIGS. 4-8, the rod 110 may further include a holding-means 130 located about the skewer-holder-end 120 (FIGS. 4-8 shows various exemplary embodiments of the holding-means 130). The holding-means 130 may be configured to hold the at least said portion of the skewer 160 in the skewer-holder-end 120 of the rod 110, thereby “locking” the skewer in the rod 110, preventing it from falling out of the skewer-holder-end 120 of the rod 110 and/or preventing it from falling further into the inner-capacity 114 of the rod 110, thereby allowing force to be applied to the skewer 160 when inserting it into the food item 5 without dislodging the skewer 160.

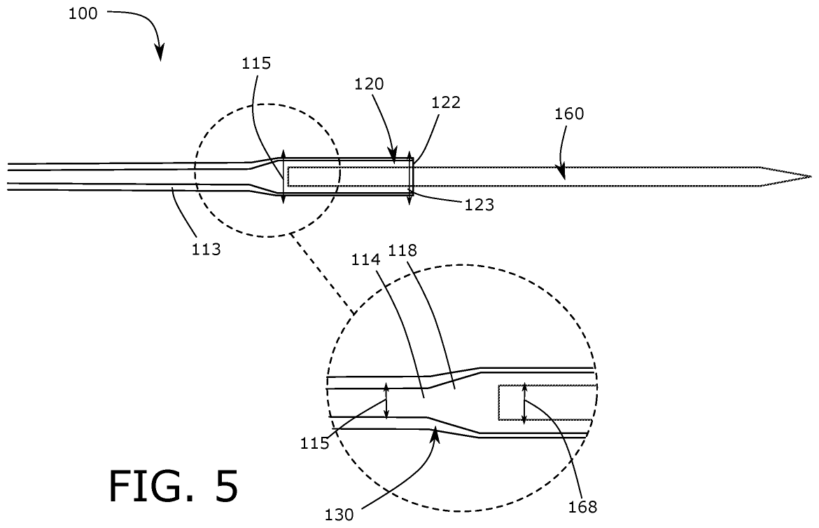

The holding-means 130 may include a section 118 of the inner capacity 114 being reduced (thereby reducing the inner capacity-diameter 115 at the section 118) such that the second-end 164 of the skewer 160 is held in stasis via friction. As shown in FIG. 4 and FIG. 5, in some embodiments the holding-means 130 may include the section 118 of the inner-capacity 114 being tapered. In this embodiment, the inner-capacity diameter 115 at the skewer-holder-end 120 and the opening-diameter 123 of the opening 122 may be larger than the skewer-diameter 168. The inner-capacity 114 may begin to taper at the section 118, thereby tapering the inner capacity-diameter 115 into a smaller diameter than the skewer-diameter 168 such that when the skewer 160 is slid into the skewer-holder-end 120, once it reaches a diameter of the section 118 which is less than the skewer-diameter 168, the skewer 160 is then held in statis via friction. In some embodiments, the section 118 of the rod 110 may be located between 1-3 inches from the skewer-holder-end 120.

In some examples, the opening-diameter 123 may be 5 mm, a smallest part of the section 118 the inner capacity-diameter 115 may be approximately 2.5 mm, and the skewer-diameter 168 may be 3 mm. It should be appreciated that these measurements are given as examples and that the tool 100 is not limited to these measurements. To achieve a variation in the inner capacity-diameter 115 without modifying an outer-surface of the rod 110, the inner-capacity 114 may include an inner-wall 113 on an inner-surface of the rod 110. Changes in a thickness of the inner-wall 113 may contribute to the variation in inner capacity-diameter 115. In this embodiment, the (tapered) section 118 may be integral to the inner-wall 113.

As shown in FIG. 5, in some embodiments the skewer-holder-end 120 may be swaged during manufacture via a swaging tool or rotary swaging machine. As shown, the outer-surface of the rod 110 may be swaged as well as the inner-capacity 114. Similarly to above, the inner-capacity diameter 115 at the skewer-holder-end 120 and the opening-diameter 123 of the opening 122 may be larger than the skewer-diameter 168. The inner-capacity 114 may begin to taper at the section 118, thereby tapering the inner capacity-diameter 115 into a smaller diameter than the skewer-diameter 168. A taper length (from a largest part of the section 118 to the smallest part of the section 118) may be between ¾-1 inch. In some examples of this embodiment, the section 118 may be 2 inches down the rod 110 from the skewer-holder-end 120. Further, as above, the inner-capacity 114 may include the inner-wall 113 and the inner-wall 113 may include the tapered section 118.

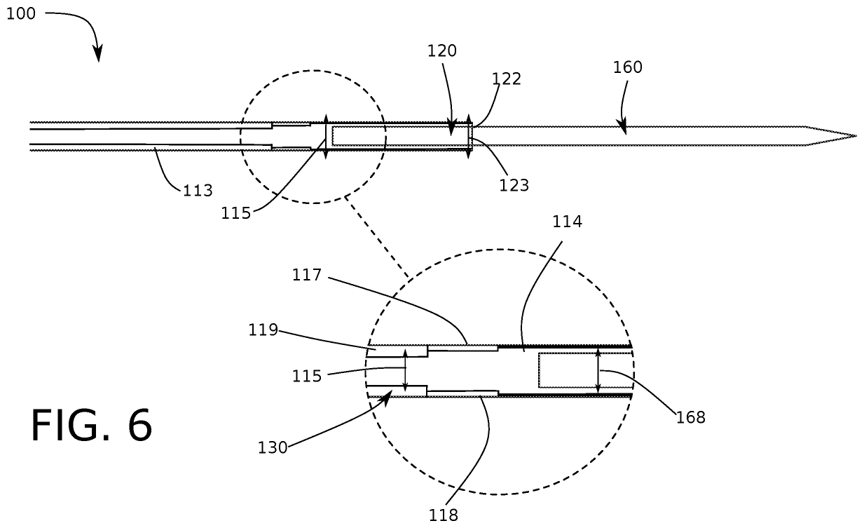

In another embodiment, as shown in FIG. 6, the holding-means 130 may include the section 118 of the inner-capacity 114 being “stepped”. In this embodiment, as shown, the section 118 may include a first step 117 and a second step 119. As above, the inner-capacity 114 may include the inner-wall 113. In this embodiment, the second step 119 may be integral to the inner-wall 113. In some examples, the opening-diameter 123 may be 5 mm; at the first step 117, the inner capacity-diameter 115 may be 3.5 mm, at the second step the inner capacity-diameter 115 may be 2.5 mm, and the skewer-diameter 168 may be 3 mm. Again, it should be appreciated that these measurements are given as examples and that the tool 100 is not limited to these measurements.

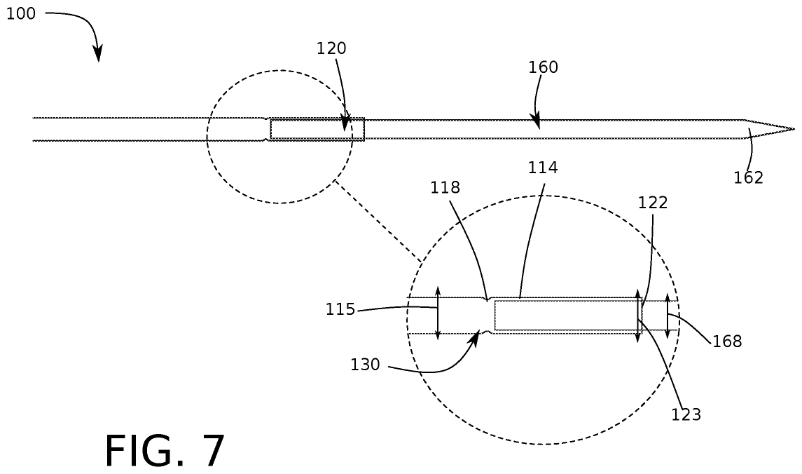

In another embodiment, as shown in FIG. 7, the holding-means 130 may include the section 118 of the inner-capacity 114 (and the outer-surface at the section 118) being crimped. For example, during manufacture, the rod 110 may be pinched, compressed, bent, etc. at the section 118. In this embodiment, the inner capacity-diameter 115 at the section 118 may be equal to the skewer-diameter 168 such that the second-end 164 of the skewer 160 is then held in stasis via friction. For example, the inner capacity-diameter 115 at the section 118 may be 3 mm, and the skewer-diameter 168 may be 3 mm. As above, it should be appreciated that these measurements are given as examples and that the tool 100 is not limited to these measurements.

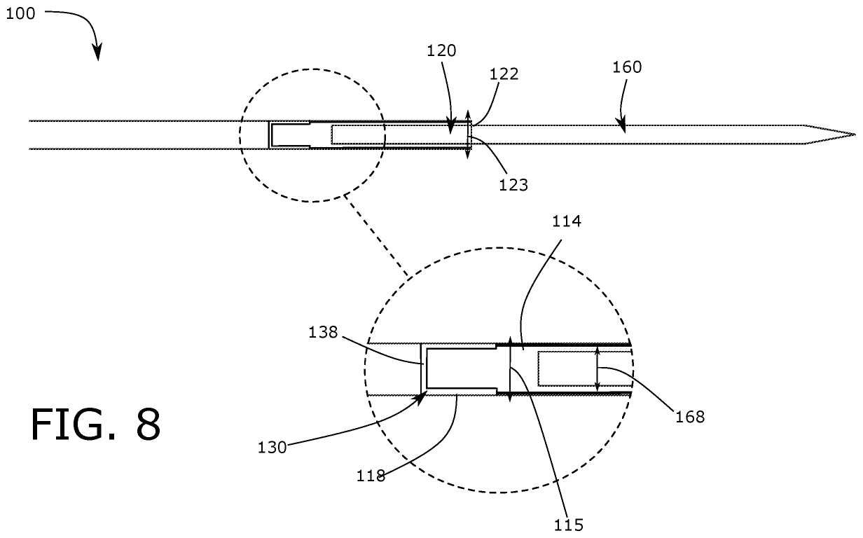

As shown in FIG. 8, the holding-means 130 may include a socket-means 138 located about the section 118 of the rod 110. The socket-means 138 may be configured to receive and hold the second-end 164 of the skewer 160. For example, the socket-means 138 may hold the second-end 164 via friction as above, may include gripping means such as internal teeth for gripping onto the second-end 164, may include a non-slip material (such as silicone or rubber) that grips the second-end 164, or the like. In this embodiment, the second-end 164 of the skewer 160 may be removably “plugged” into the socket-means 138.

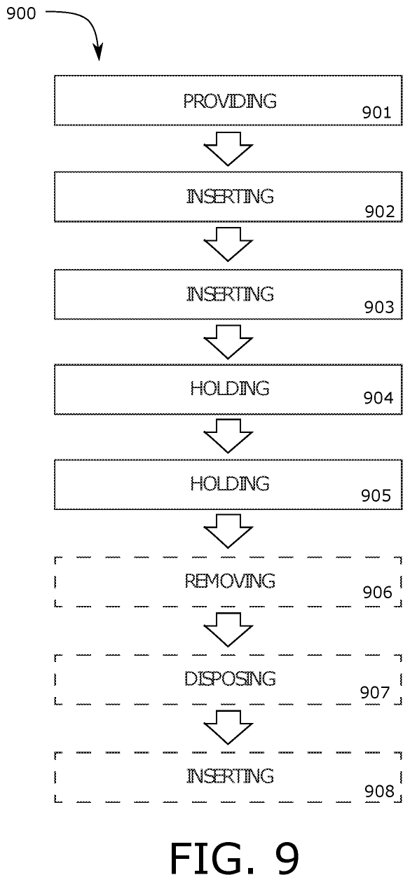

Referring now to FIG. 9 showing a flow diagram illustrating a method 900 of using a tool with food items, according to an embodiment of the present disclosure. In particular, the method 900 may include one or more components or features of the tool 100 as described above. As illustrated, the method of use 900 may include the steps of: step one 901, providing the tool as above; step two 902, inserting a second-end of the skewer into the opening until the holding-means holds the at least said portion of the skewer in the skewer-holder-end of the rod; step three 903; inserting a first-end of the skewer into a food item, the first-end including a spike for holding the food item; step four 904, holding the handle of the rod; step five 905, holding the food item over a heat source to cook the food item. Further steps may include step six 906, removing the skewer from the rod; step seven 907, disposing of the skewer; and step eight 908, inserting another skewer into the skewer-holder-end of the rod.

It should be noted that step six 906, step seven 907, and step eight 908 are optional steps and may not be implemented in all cases. Optional steps of method of use 900 are illustrated using dotted lines in FIG. 9 so as to distinguish them from the other steps of method of use 900. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of using a tool with food items, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A tool for use with food items, the tool comprising:
a rod, the rod having a body being at least partially hollow and defining an inner-capacity, the rod including:
a skewer-holder-end including an opening permitting entrance to the inner-capacity, the opening configured to removably receive at least a portion of a skewer therein;
a holding-means located about the skewer-holder-end, the holding-means being configured to hold the at least said portion of the skewer in the skewer-holder-end of the rod;
a handle-end opposite the skewer-holder-end, the handle-end including a handle; and
and an elongated length between the skewer-holder-end and the handle-end.

2. The tool of claim 1, further comprising the skewer which is removable.

3. The tool of claim 2, wherein the skewer includes a first-end opposite a second-end, wherein the first-end includes a spike for holding a food item, and wherein the second-end is configured for insertion into the skewer-holder-end.

4. The tool of claim 3, wherein the skewer is disposable.

5. The tool of claim 4, wherein the skewer comprises a first wood material.

6. The tool of claim 1, wherein the rod is substantially hollow.

7. The tool of claim 1, wherein the opening includes an opening-diameter, wherein the inner-capacity includes an inner capacity-diameter and wherein the opening-diameter and the inner capacity-diameter are substantially equal to a skewer-diameter of the skewer.

8. The tool of claim 7, wherein opening-diameter and the inner capacity-diameter are between 3-5 mm.

9. The tool of claim 8, wherein the holding-means includes a section of the inner capacity being reduced, thereby reducing the inner capacity-diameter at the section such that the second-end of the skewer is held in stasis via friction.

10. The tool of claim 1, wherein the holding-means includes a socket-means located about said section of the rod, the socket-means being configured to receive and hold the second-end of the skewer.

11. The tool of claim 1, wherein the section of the rod is located between 1-3 inches from the skewer-holder-end.

12. The tool of claim 1, wherein the handle comprises a second wood material.

13. The tool of claim 1, wherein the rod comprises a substantially metal material.

14. The tool of claim 13, wherein the substantially metal material is stainless steel.

15. A tool for use with food items, the tool comprising:
a skewer, the skewer being disposable and including a first-end opposite a second-end, the first-end including a spike for holding a food item; and
a rod, the rod being at least partially hollow and defining an inner-capacity, the rod including:
a skewer-holder-end including an opening permitting entrance to the inner-capacity, the opening configured to removably receive at least a portion of the skewer therein, the second-end of the skewer being configured for insertion into the skewer-holder-end;
a holding-means located about the skewer-holder-end, the holding-means being configured to frictionally hold the at least said portion of the skewer in the skewer-holder-end of the rod;
a handle-end opposite the skewer-holder-end, the handle-end including a handle;
and an elongated length between the skewer-holder-end and the handle-end; and
wherein the opening includes an opening-diameter, wherein the inner-capacity includes an inner capacity-diameter and wherein the opening-diameter and the inner capacity-diameter are substantially equal to a skewer-diameter of the skewer.

16. The tool of claim 15, wherein the rod is substantially hollow.

17. The tool of claim 15, wherein the holding-means includes a section of the inner capacity being reduced, thereby reducing the inner capacity-diameter at the section such that the second-end of the skewer is held in stasis via friction.

18. The tool of claim 15, wherein the holding-means includes a socket-means located about said section of the rod, the socket-means being configured to receive and hold the second-end of the skewer.

19. A method of using a tool with food items, the method comprising the steps of:
providing the tool including:
a rod, the rod being at least partially hollow and defining an inner-capacity, the rod including:
a skewer-holder-end including an opening permitting entrance to the inner-capacity, the opening configured to removably receive at least a portion of a skewer therein;
a holding-means located about the skewer-holder-end, the holding-means being configured to hold the at least said portion of the skewer in the skewer-holder-end of the rod;
a handle-end opposite the skewer-holder-end, the handle-end including a handle;
and an elongated length between the skewer-holder-end and the handle-end;
inserting a second-end of the skewer into the opening until the holding-means holds the at least said portion of the skewer in the skewer-holder-end of the rod;
inserting a first-end of the skewer into a food item, the first-end including a spike for holding the food item;
holding the handle of the rod; and
holding the food item over a heat source to cook the food item.

20. The method of claim 19, further comprising the steps of
removing the skewer from the rod;
disposing of the skewer; and
inserting another skewer into the skewer-holder-end of the rod.
